(19) United States
(12) Patent Application Publication
(10) Pub. No.: US 2026/0027524 A1
(43) Pub. Date: Jan. 29, 2026

(54) PRESSURE RETARDED OSMOSIS JELLY ROLL MEMBRANE ASSEMBLY

(71) Applicant: Lonnie G. Johnson, Atlanta, GA (US)

(72) Inventor: Lonnie G. Johnson, Atlanta, GA (US)

(21) Appl. No.: 19/093,582

(22) Filed: Mar. 28, 2025

Related U.S. Application Data
(60) Provisional application No. 63/571,030, filed on Mar. 28, 2024.

(51) Int. Cl. B01D 63/12; B01D 53/22; B01D 53/26; B01D 61/00; B01D 69/12; C02F 1/44; C02F 103/08; E03B 3/28

(52) U.S. Cl. CPC B01D 63/12; B01D 53/226; B01D 53/228; B01D 53/268; B01D 61/0022; B01D 69/12; C02F 1/445; E03B 3/28; B01D 2053/221; B01D 2257/80; B01D 2313/105; B01D 2313/125; C02F 2103/08

(57) ABSTRACT

A membrane assembly for extracting water from ambient air or seawater includes a manifold tube surrounded by a membrane web arranged about the manifold tube in a spiral configuration. The manifold tube has an entrance end, an exit end, web entrance ports, and web exit ports. The web membrane has a first osmosis membrane, a second osmosis membrane, a barrier layer positioned between the first osmosis membrane and the second osmosis membrane to form a first fluid flow conduit in fluid communication with the web entrance ports and a second fluid flow conduit in fluid communication with the web exit entrance ports and an end of the first fluid flow conduit. The web membrane also has a first porous structural material layer positioned within the first and second fluid flow conduit, and a second porous structural material layer positioned about the first osmosis membrane.

### REFERENCE TO RELATED APPLICATION

This application claims the benefit of U.S. Provisional Patent Application No. 63/571,030 filed Mar. 28, 2024 and entitled “Pressure Retarded Osmosis Jelly Roll Membrane Assembly”, which are incorporated herein by reference in their entirety.

### TECHNICAL FIELD

This invention relates generally an improved power generator and ambient water condenser device, system and method. The invention operates on heat and is configured to simultaneously provide potable water extracted from ambient air and electrical power.

### BACKGROUND OF THE INVENTION

With the Earth's population exceeding seven billion people, there is an increasing need to provide sources of fresh potable water, especially in arid climates and underdeveloped areas with limited access to water. Although the Earth's surface is approximately seventy-one percent water, over ninety-seven percent of this water is found in oceans making it non-potable. The remaining approximately three percent of the Earth's water exists as water vapor, in rivers, in lakes, in icecaps, in glaciers, in ground water, and in aquifers. With the Earth's population exceeding seven billion people, there is an increasing need to provide sources of fresh potable water, especially in arid climates and underdeveloped areas with limited access to water.

Approaches for providing fresh water include atmospheric water condensation, water distillation and reverse osmosis systems for harvesting water from salty ocean or sea water and fog harvesters that are used specialized high surface materials to collect potable water from fog. The predominant process for extracting water from ambient air is by use of electrical energy driven refrigeration cycles which consume very large amounts of energy. Many of these systems are expensive requiring bulky inefficient components operating in sizable water condensation systems. In general, these solutions are quite cumbersome, inefficient, and expensive as well. None of them produce electricity during the condensation process. In fact, a major challenge with existing systems is associated with the large amounts of energy required for their operation. The energy challenge is made even more difficult by the existing global need to reduce dependance on fossil fuels for power generation.

The Los Angeles Times recently published an article addressing the State of California's water stressed condition entitled: “‘A ticking time bomb’: Why California can't provide safe drinking water to all its residents”, 09 27 23. According to the American Public Power Association, collectively, the U.S. electric power sector used 47.5 trillion gallons of water in 2020. This is equivalent to 25% of the USGA reported 208 trillion gallons per year mainstream flow of the Mississippi River at Vicksburg. Energy production is completing with human consumption, manufacturing, and food irrigation.

There is increasing reliance on desalination of ocean and sea water as a means for producing fresh water. Reverse osmosis desalination plants consume electricity to produce water. Distillation desalination plants consume heat to produce freshwater. Heat driven distillation and electrically driven reverse osmosis are well established industries processes for producing freshwater from sea water. Both approaches consume large amounts of energy. In fact, one of the most difficult challenges facing freshwater production in seawater desalination plants is the amount of energy consumed. To address this issue, the approach presented here uses the heat of condensation of ambient humidity as an energy source to reduce the amount of external energy needed to drive the process. To introduce this novel approach, examples are shown under ideal conditions without accounting for real world flow losses or heat transfer inefficiencies.

It can be shown that by far, most of the water stressed regions of the world have more than adequate humidity in the air for use as a source of freshwater.

Although there are overlapping features, use of atmospheric humidity condensers to produce freshwater is not as mature as ocean water desalination. Use of electrical energy driven refrigeration cycles to condense ambient humidity is known but less popular. Known freshwater producing freshwater production approaches consume large amounts of energy and are generally carbon footprint intensive. Other techniques include fog harvesters that used specialized membranes and surfaces (metal organic frameworks) to collect potable water ambient air. Still, these systems require large amounts of energy to evaporate water out of the colleting materials.

Accordingly, there is a need for improved, efficient, inexpensive atmospheric water extraction system that generates electrical power at the same time. This need and other needs are satisfied by the various aspects of the present disclosure.

### SUMMARY OF THE INVENTION

A pressure retarded osmosis jelly roll membrane assembly or water extraction membrane assembly comprises a manifold tube having an entrance end, an exit end oppositely disposed from the entrance end, at least one web entrance port extending through the manifold tube and positioned between the entrance end and the exit end, at least one web exit port extending through the manifold tube and positioned between the at least one web entrance port and the exit end, and a central seal positioned within the manifold tube between the at least one web entrance port and the at least one web exit port. The water extraction membrane assembly also includes a membrane web positioned about the manifold tube in a spiral configuration wherein the membrane web has a first osmosis membrane coupled to the manifold tube, a second osmosis membrane coupled to the manifold tube, a barrier layer coupled to the manifold tube and positioned between the first osmosis membrane and the second osmosis membrane to form a first fluid flow conduit in fluid communication with the at least one web entrance port and a second fluid flow conduit in fluid communication with the at least one web exit entrance port and an end of the first fluid flow conduit. The water extraction membrane assembly also has a first porous structural material layer positioned within the first fluid flow conduit and the second fluid flow conduit, and a second porous structural material layer positioned about the first osmosis membrane oppositely disposed from the first porous structural material layer.

### BRIEF DESCRIPTION OF THE DRAWINGS

FIG. 1 is a heat driven atmospheric water vapor extracting freshwater and power generator that utilizes the pressure retarded osmosis jelly roll membrane assembly shown in FIGS. 6A-11.

FIG. 2 is a graph showing the sequential reheats that occur at each stage of the multi-stage flash process for the system of FIG. 1.

FIG. 3 is another heat driven atmospheric water vapor extracting freshwater and power generator that utilizes the pressure retarded osmosis jelly roll membrane assembly shown in FIGS. 6A-11.

FIG. 4 is a graph showing the sequential reheats that occur at each stage of the multi-stage flash process for the system of FIG. 1.

FIG. 5 is a graph showing the sequential reheats that occur at each stage of the multi-stage flash process for the system of FIG. 1.

FIG. 6A is manifold tube of a pressure retarded osmosis jelly roll membrane assembly embodying principles of the invention in a preferred form shown in FIG. 6B.

FIG. 6B is the pressure retarded osmosis jelly roll membrane assembly embodying principles of the invention in a preferred form, shown in a partially unrolled configuration.

FIG. 7 is a cross-sectional view of a portion of the pressure retarded osmosis jelly roll membrane assembly of FIG. 6B.

FIG. 8 is a cross-sectional view of the pressure retarded osmosis jelly roll membrane assembly of FIG. 6B, shown in a partially unrolled configuration.

FIG. 9A is perspective view of the pressure retarded osmosis jelly roll membrane assembly of FIG. 6B.

FIG. 9B is cross-sectional view of the pressure retarded osmosis jelly roll membrane assembly of FIG. 9A.

FIG. 10A is a perspective view of another embodiment of the pressure retarded osmosis jelly roll membrane assembly.

FIG. 10B is cross-sectional view of the pressure retarded osmosis jelly roll membrane assembly of FIG. 6B.

FIG. 11 is a perspective view of another embodiment of the pressure retarded osmosis jelly roll membrane assembly.

### DETAILED DESCRIPTION

The present disclosure is for a pressure retarded osmosis jelly roll membrane assembly that is used with a heat driven atmospheric water vapor extracting freshwater and power generator. The water and power generator includes a housing that contains a recuperative heat exchanger, hygroscopic solution, an ionizable non-condensable gas, preferably hydrogen or oxygen, and an electrochemical concentration cell. The housing includes a hydrophobic membrane that is water vapor permeable. The water vapor permeable membrane couples the hygroscopic solution to ambient. The concentration cell includes a membrane that is conductor of non-condensable gas ions. The membrane is sandwiched between a pair of electrodes whereby power is generated under the non-condensable gas partial pressure differential applied across the cell.

The generator is coupled to a heat source and a heat sink. The hygroscopic solution and ionizable gas are contained within the housing and may operate at a total fluid pressure that is higher than the atmospheric pressure of ambient air at ambient temperature. However, at ambient temperature, the water vapor pressure of the hygroscopic solution is reduced below the partial water vapor (humidity) pressure of ambient air. The water vapor permeable membrane functions as a barrier that contains the hygroscopic solution under its pressure while allowing water vapor to enter and condense into the solution. A distillation process is used to evaporate water from the solution by heating the solution to an elevated temperature to increase its water vapor pressure. After releasing steam, the hygroscopic solution is subsequently cooled to reduce its water vapor pressure and returned to the water vapor permeable barrier for continued ambient water vapor absorption.

The total pressure within the housing is the same at all locations. Heat driven temperature changes result in gas (ionizable gas vs. steam) partial pressure changes from one location to the other. Steam generated in the distillation process is supplied to and maintains low partial pressure of the ionizable gas at the low partial pressure electrode. Power is generated as high partial pressure ionizable gas is supplied to the high partial pressure electrode on the opposite side of the membrane. Ionizable gas is conducted through the cell under the pressure differential and mixes with the steam supplied to the low-pressure electrode. The mixed gas leaving the low partial pressure electrode is supplied to a heat exchanger which is coupled to the heat sink for heat rejection. Heat extraction by the heat sink causes condensation of freshwater from the mixed gas flow. Steam condensing from the mixed gas flow leaves high partial pressure ionizable gas which is supplied to the high partial pressure electrode as the process continues. The resulting electrical power and freshwater is available for external consumption.

A series of water and power generators may be optionally configured in a multi-stage flash evaporation approach to recuperate heat of condensation from steam exiting the distillation process for use as heat of evaporation of water from hygroscopic solution in sequential stages. The generators may be thermally coupled in series between a main heat source and a main sink. The generators are thermally coupled together intermediate recuperative heat exchangers which transfer condensation heat from one generator to the next in series for use as heat of evaporation. Each generator in the sequence operates at a lower pressure than the one preceding so that it generates steam at a lower temperature than the one preceding it.

There are numerous applications where an inexpensive device that extracts water from the ambient atmosphere would be useful. Applications range from supplying power and water for farm irrigation, power and freshwater in geographically remote locations where power and freshwater is scarce, to reducing the grid load of buildings for HVAC and other applications. The heat to drive the process may be provided from a range of sources depending on the application including geothermal, solar or waste heat such as that released by industrial processes. The invention can be used for large scale production of drinking water in arid climates or supplying dry air to buildings, solar could be an attractive heat source. On the other hand, waste heat from cooking stoves could be used for production of water in smaller scale applications such as watering household flower plants or building.

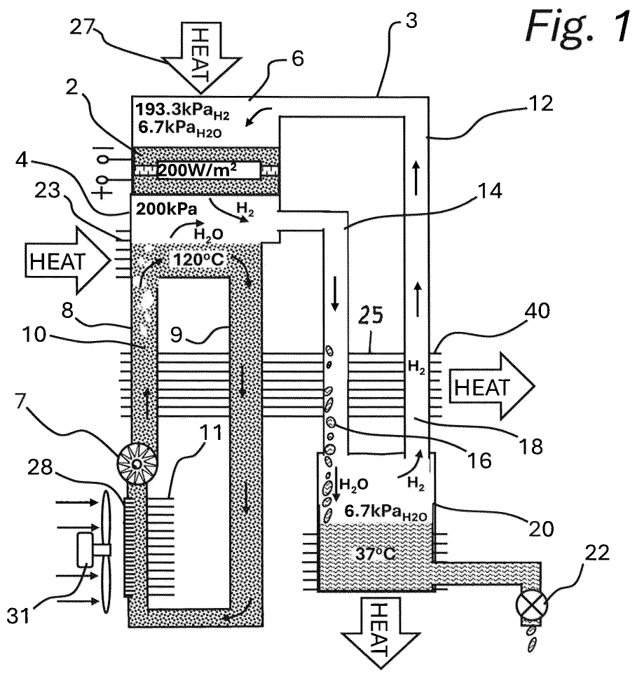

Hydrogen is presented as the ionizable gas here in describing operation of the invention. Alternate ionizable working fluids are an option and therefore considered protected by this patent. FIG. 1 shows a heat and atmospheric water vapor driven freshwater and power generator that is representative of the present invention. The basic device includes housing 3 which contains proton conductive membrane electrode assembly (MEA) 2, an ionizable gas 18 such as hydrogen, high hydrogen partial pressure chamber 6, low hydrogen partial pressure chamber 4, hygroscopic solution circulation conduit sections 8 and 9, hygroscopic solution circulation pump 7, hygroscopic solution 10, water vapor permeable barrier 28, water evaporation heat exchanger 24, condenser heat exchanger 26 and condensed water reservoir 20 having a control valve 22. The electrodes of MEA 2 include a catalyst that promotes electrochemical oxidation/reduction reactions. The total hydrostatic fluid pressure inside housing 3 is the same at all locations inside the device and may be higher than the atmospheric pressure of ambient air. Water evaporation and condensation processes are used to create hydrogen partial variations at selected locations, and particularly, a pressure differential across membrane electrode assembly 2.

At ambient temperature, the water vapor pressure of the hygroscopic solution is reduced below the partial water vapor (humidity) pressure of ambient air such that water vapor can permeate through porous hydrophobic vapor permeable barrier 28 into hygroscopic solution 10. The hydrophobic vapor permeable membrane functions as a barrier that contains the hygroscopic solution under its hydrostatic pressure differential relative to ambient while allowing water vapor to enter and condense into the solution.

A circulation pump 7 forces circulation through circulation conduit sections 8 and 9 which conduct hygroscopic solution 10 flow between water vapor permeable barrier 28, heat exchanger 24, and low hydrogen partial pressure chamber 4. Circulation device 31 supplies ambient air and thereby ambient moisture to hygroscopic solution 10. Hygroscopic solution 10 circulating within circulation conduit section 8 absorbs ambient water vapor (humidity) through vapor permeable barrier 28. A heat exchanger 11 extracts heat of absorption from hygroscopic solution 10 as it absorbs moisture (water vapor) to maintain it at low vapor pressure to achieve sustained absorption of moisture as the solution flows past water permeable barrier 28. Water permeable barrier 28, heat exchanger 11 and circulation pump 7 operate together to function as a water aerator. Heat evaporates water from water rich hygroscopic solution 10 as it passes through heat exchanger 24. The resulting mixture of steam and water depleted solution passes through pressure chamber 4 to maintain low hydrogen partial pressure therein. The water depleted hygroscopic solution 10 flows back to circulation pump 7 through circulation conduit section 9 and continues its circulation process of carrying water vapor to pressure chamber 4 whereas the steam mixes with hydrogen which enters pressure chamber 4 through the MEA 2. The mixed hydrogen and steam flows into a conduit 14 and on through recuperative heat exchangers 25 and 40.

Heat extraction from the gas mixture passing through recuperative heat exchanger 25 and on into condenser heat exchanger 26 condenses the steam therein resulting in separation of water 16 from the hydrogen gas portion of the mixture. The condensed water 16 accumulates in condensed water reservoir 20 as hydrogen/ionized gas 18 separates and flows into a conduit 12 and on into high hydrogen partial pressure chamber 6. The process causes predominantly high steam partial pressure to be maintained within pressure chamber 4 and predominantly high partial pressure hydrogen to be maintained within pressure chamber 6 which results in a high hydrogen pressure differential across the MEA 2.

The hydrogen partial pressure differential produces a voltage differential between the electrodes of MEA 2, with the electrode within pressure chamber 4 functions as a low pressure electrode and the electrode within pressure chamber 6 functions as a high pressure electrode. With a load connected between the electrodes, hydrogen is oxidized by the electrode in high partial pressure chamber 6. The resulting protons are conducted through the proton conductive membrane within MEA 2 as the resulting electrons are conducted through the external load. The electrons and protons are reduced back to hydrogen by the electrode in low partial pressure chamber 4 as steam flow therethrough maintains a low hydrogen partial pressure therein.

Freshwater accumulated within condensed water reservoir 20 is available for external use. Recuperative heat exchangers 24 and 25 assist in providing thermal isolation between the high and low temperature sections of the freshwater and power generator. Heat exchanger 24 recovers heat by conducting heat from fluid leaving pressure chamber 4 and conducting it to fluid flowing to pressure chamber 4, to minimize the amount of heat needed to bring hygroscopic solution 10 to the temperature of pressure chamber 4. Similarly, heat exchanger 25 recovers heat by conducting heat from mixed steam and hydrogen gas leaving pressure chamber 4 and conducting it to substantially high-pressure hydrogen in conduit 12 flowing to pressure chamber 6. Ideally, heat of expansion 27 is supplied independently to hydrogen being conducted through MEA 2 to maintain an isothermal expansion process.

The electrical potential due to the ionizable gas (i.e., hydrogen or alternative working fluid) pressure differential across a membrane electrode assembly (MEA 2) is proportional to the natural logarithm of the hydrogen pressure ratio, and can be calculated using Nernst Equation 1:

$${V}_{OC} = \frac{nR T Ln ( \frac{{P}_{H}}{{P}_{L}} )}{2 F}$$

where VOC is open circuit voltage, R is the universal gas constant, T is the cell temperature, F is Faraday's constant, PH is the pressure on the high pressure side, PL is the pressure on the low pressure side, and PH/PL is the pressure ratio. E.g., Fuel Cell Handbook, J. H. Hirschenhofer et al., 4th Edition, p. 2-5 (1999). The voltage is linear with respect to temperature and is a logarithmic function of the pressure ratio.

Note that the total internal operating pressure of the example shown in FIG. 1 is 200 kPa. At the condensation reservoir temperature of 37° C., the vapor pressure of water is 6.7 kPa which results in a hydrogen partial pressure of 193° C. On the other hand, the vapor pressure of steam at the 120° C. temperature of evaporation pressure chamber 4 is 200 kPa which results in a hydrogen partial pressure of essentially zero given 200 kPa is the total internal pressure of the converter. The configuration maximizes the pressure differential across MEA 2 and thereby maximizes the voltage generated and power density.

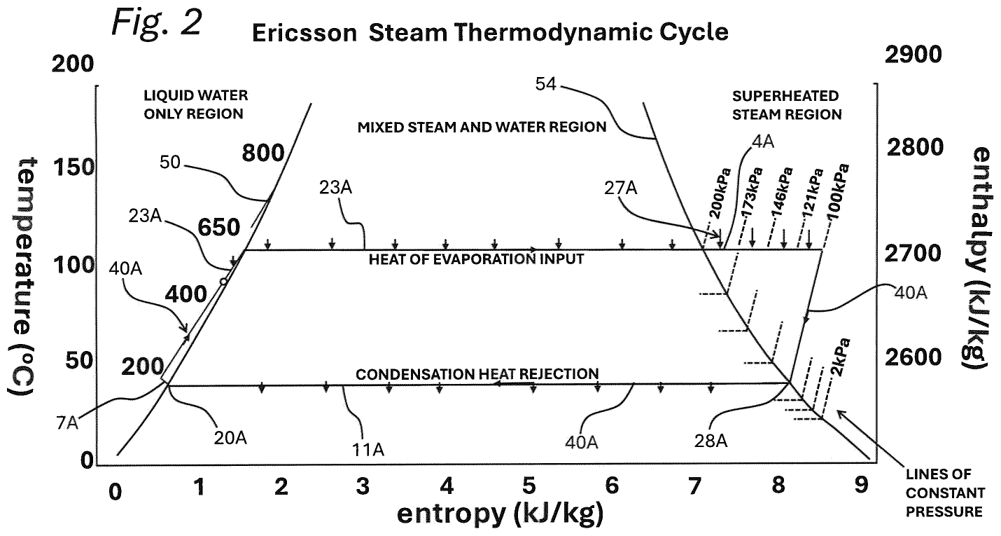

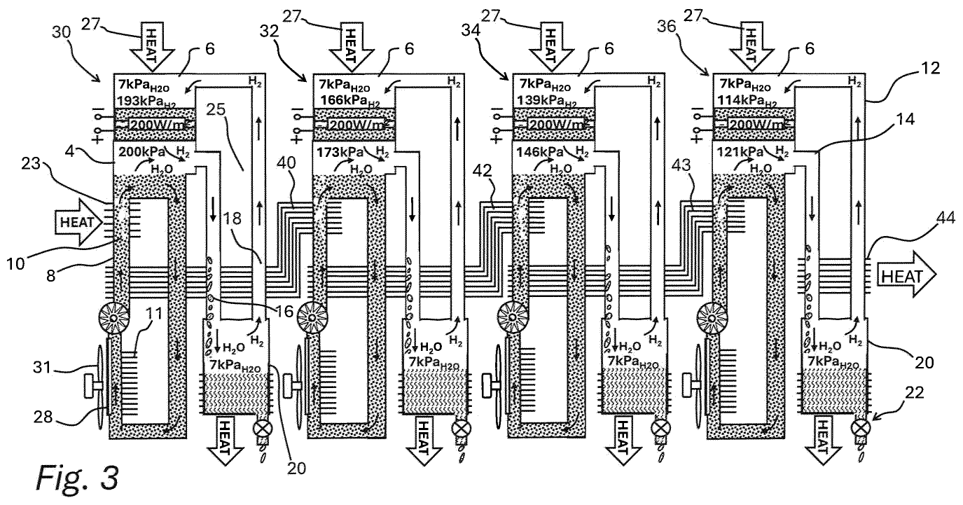

As illustrated by FIG. 2, the constant temperature process occurring in pressure chamber 4 enables the converter illustrated in FIG. 1 to approximate an Ericsson thermodynamic cycle for steam. The Ericsson cycle is characterized by constant pressure heating followed by a constant temperature expansion then constant pressure cooling and finally constant temperature compression. The converter operates on an open cycle condensing water from ambient into a hygroscopic solution and then extracting it in a distillation process. Referring to the first stage in FIGS. 2 and 3, starting at condensation heat rejection line 28A, water vapor is condensed from ambient air or sea water via aerator or vapor permeable barrier 28. Heat rejection by heat exchanger 11 maintains a constant temperature process as indicated by line 11A. Circulation pump 7 supplies water latent solution to recuperative heat exchanger 40 as indicated by 7A. Recuperative heat exchanger 40 couples sensible heat from fluids leaving low pressure evaporation pressure chamber 4 as indicated by lines 40A. The hygroscopic solution enters heat exchanger 23 where the heat brings the temperature to the saturated liquid state. Continued heating evaporates water from the hygroscopic solution as indicated by 23A. In pressure chamber 4, steam released from hygroscopic solution 10 expands at constant temperature in superheated region 4A with hydrogen entering from MEA 2 as heat is supplied from heat source 27 as indicated by 27A. Cooling and condensation of the steam occurs as it passes through heat exchangers 40 and indicated by line 40A in FIG. 2. Condensed freshwater accumulates in water reservoir 20 as heat exchanger 40 reheats high partial pressure hydrogen transitioning to high partial pressure chamber 6 through conduit 12.

The hydrogen partial pressure differential across MEA 2 decreases as the hydrogen content within pressure chamber 4 increases as hydrogen expands through MEA 2. FIG. 3 illustrates connection of several converters in series in a multistage flash evaporation sequence to achieve efficient use of the initial heat of evaporation input to the first converter stage. The configuration provides an ability to limit the amount of hydrogen allowed into the respective low hydrogen partial pressure chambers at each stage to a level that maintains high MEA power density. The heat of vaporization supplied to the converter 30 is reused sequentially by coupling it from one stage to the next. Heat exchanger 40 couples heat for condensation from converter 30 to converter 32 for use as heat of vaporization. Similarly, heat exchanger 42 couples heat of condensation from converter 32 to converter 34 for use as heat of vaporization. Finally, recuperative heat exchanger 43 couples heat of condensation from converter 34 to converter 36 for use as heat of vaporization. Final heat exchanger 44 rejects heat of condensation of converter 36 to the environment. Note that each successive converter operates at a total internal pressure that is lower than that of the converter that precedes it. Operating in this manner the heat of condensation at the higher pressure of the preceding converter can effectively be used as heat of vaporization at the lower temperature and saturation pressure of the subsequent stage.

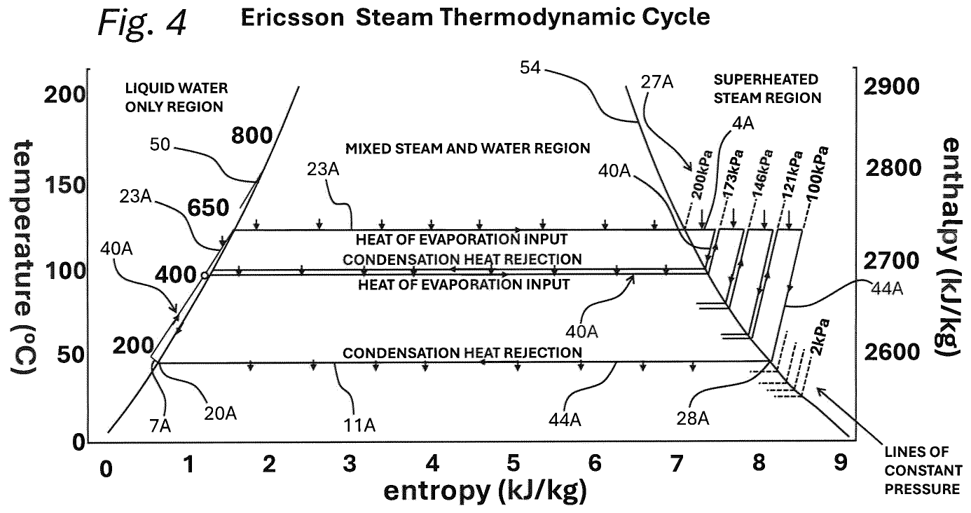

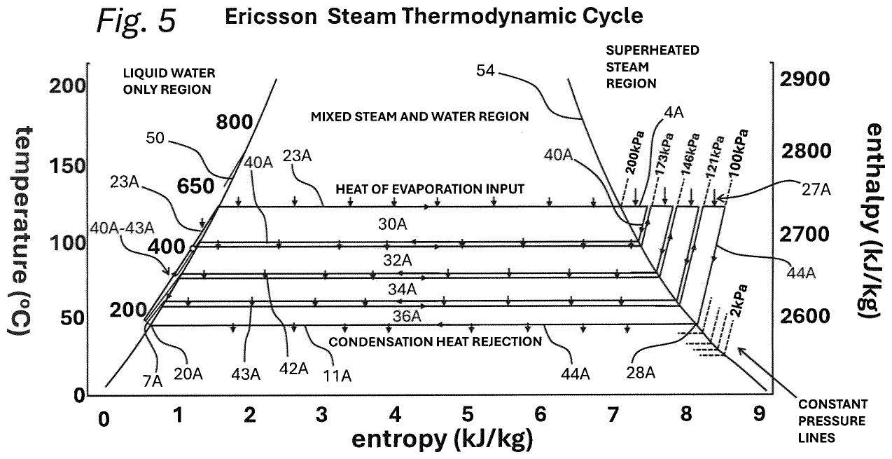

FIGS. 4 and 5 illustrate the sequential reheats that occur at each stage of the multi-stage flash process shown in FIG. 3 leading to sequential isothermal expansions in the superheated steam region with heat input from heat source 27 as represented by 27A. Atmospheric water condenses into hygroscopic solution 10 at aerator or vapor permeable barrier 28 as represented in FIG. 4 as 28A with heat rejection by heat exchanger 11 as indicated by 11A. The temperature of the solution increases passing through recuperative heat exchanger 40 as indicated by 40A. Heat exchanger 23 heats the hygroscopic solution to water evaporation temperature and subsequent steam generation as indicated in FIGS. 4 and 5 by lines 23A. The partial pressure of steam decreases at constant temperature within pressure chamber 4 as hydrogen enters and heat is supplied by heat sources 27. See constant temperature expansion 4A in FIGS. 4 and 5. After expansion, the hydrogen steam mixture and water depleted hygroscopic solution 10 enters recuperative heat exchanger 40 to transfer sensible heat to solution within conduit section 8 flowing to pressure chamber 4 and to hydrogen within conduit 12 flowing to pressure chamber 6. As opposed to rejecting heat of condensation to ambient, heat exchanger 40 in FIG. 3 rejects the heat to the next converter in the series, at a temperature that is above ambient but sufficient to evaporate water from the water latent solution at the lower operating pressure of converter 32.

The ideal T-S diagram in FIG. 5 shows the thermodynamic states for the sequence of flash evaporation stages shown in FIG. 2 with each stage condensing ambient water vapor beginning at 28A and then releasing condensed freshwater at 20A. Beginning with cycle 30A, water condenses into the aerator at 28A, pumped to pressure at 7A, heated at 40A and then further heated at 23A. The heating process at 23A further elevates the solution's temperature to the saturated liquid temperature and then evaporation of steam from the solution through to the saturated vapor point. With the addition of hydrogen and continued heating at 27A, steam enters isothermal expansion process 4A in the superheated region of the TS diagram. Heat recuperation process 40A couples heat to cycle 32A. Steam in cycle 30A is cooled at constant pressure in the superheated region down to saturated vapor temperature as steam in cycle 32A is heated at constant pressure to temperature 27A. Process 40A then transfers constant temperature and pressure phase change heat from cycle 30A to cycle 32A with the steam within cycle 32A being at a lower temperature and pressure. After condensation, process 40A transfers sensible heat from solution and water in cycle 30A to liquid solution in cycle 32. This part of process 40A increases the temperature of solution in cycle 32A to its saturated water temperature as Freshwater condensed in cycle 30A is reduced to near ambient and released.

The process continues as recuperative heat transfer process 42A couples heat from cycle 32A for cooling and condensation to cycle 34A for heating and evaporation with subsequent expansion at constant temperature 27A during power generation. Similarly, heat removed from cycle 34A for cooling and condensation by recuperative process 43A is supplied to cycle 34A for heating and evaporation with subsequent expansion at constant temperature 27A during power generation. Cycle 36A is the final cycle in the sequence. Just as in the preceding cycles, after isothermal expansion at temperature 27A during power generation, steam in cycle 36A is cooled by process 44A from superheated to condensation and subsequently to ambient temperature where it is released as freshwater. However, process 44A represents transfer of heat to ambient as opposed to a subsequent cycle.

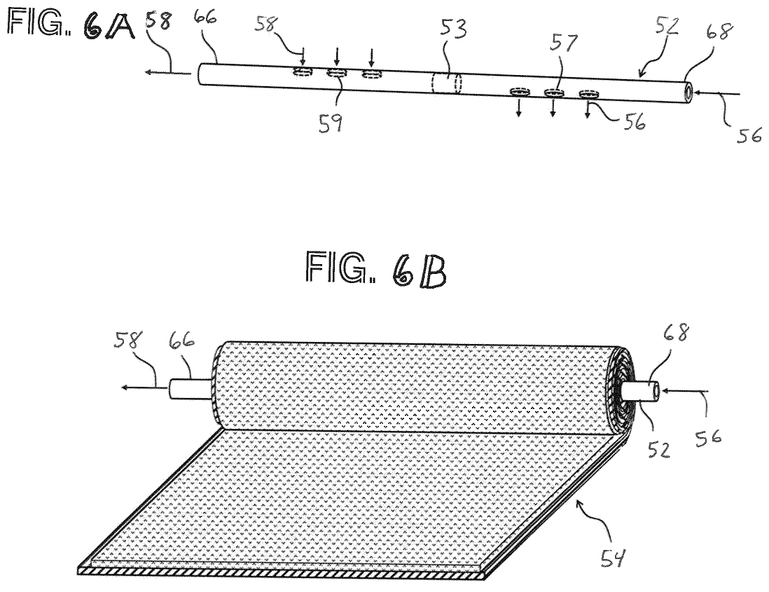

Referring now to FIG. 6, which illustrates a jelly roll pressure retarded osmosis membrane or pressure retarded osmosis membrane assembly 50 that is used as the vapor permeable barrier 28 of the previously described converters, referenced hereinafter simply as membrane assembly 50. The membrane assembly 50 that includes manifold tube 52, shown alone in FIG. 6A, and multilayer membrane web 4. The membrane web 54 is shown partially rolled around manifold tube 52 to illustrate construction of the membrane assembly 50, the completed membrane web 54 is formed about the manifold tube 52 in a spiral configuration. Functionally, a middle or central seal, stopper, block or plug 53 is positioned within the manifold tube 52 prevents fluid from passing the entire length of the manifold tube 52. As such, hygroscopic fluid or solution 10 enters manifold tube 52 at end 68 and exits the manifold tube 52 at web entrance ports 57 and into the membrane web 54, as indicated by arrows 56. The hygroscopic fluid 10 flows in plane through or within the membrane web 54. The hygroscopic fluid 10 then exits the membrane web 54 and flows back into manifold tube 52 through web exit ports 59. The hygroscopic fluid 10 then leaves manifold tube 52 at end 66, as indicated by arrows 58.

FIG. 7 shows the cross-sectional structure of converter 50, including the manifold tube 52 and the membrane web 54 coupled to the manifold tube 52. The membrane web 54 includes a first porous structural material layer 72 that is folded about a barrier layer 70 and enclosed by a first osmosis membrane 74, a second osmosis membrane 76, and edge seals 80 so as to form a first hygroscopic fluid flow channel or conduit 72A (first osmotic fluid flow conduit or channel) extending from a second hygroscopic fluid flow channel or conduit 72B (second osmotic fluid flow conduit or channel). A hygroscopic fluid or solution 10 is contained within the first porous structural material layer 72. The first porous structural material layer 72 and the first and second osmosis membranes 74 and 76 are sandwiched between a second porous structural material layer 60 which comprise or acts as a feed fluid flow conduit or flow channel through the second porous structural material layers 60, as indicated by arrows 81. Barrier layer 70 separates the first porous structural material layer 72 into the first hygroscopic fluid flow channel, conduit, or portion 72A (through material layer 72) and the second hygroscopic fluid flow channel 73B (through material layer 73) with the first hygroscopic fluid flow channel 72A interfacing with the second osmosis membrane 76 and the second hygroscopic fluid flow channel 73B interfacing with first osmosis membrane 74. As illustrated by the drawing, permeate (water vapor) 82, indicated by arrows 82, from feed fluid flow, indicated by arrow 81, is extracted from feed fluid flow 81 into the hygroscopic solution within the first porous structural material layer 72 within the hygroscopic fluid flow channels 72A and 72B through osmosis membranes 76 and 74 respectively. In this example, the feed fluid is ambient air or sea water, the permeate is ambient humidity (water vapor) and the osmotic fluid is a hygroscopic salt such as lithium chloride.

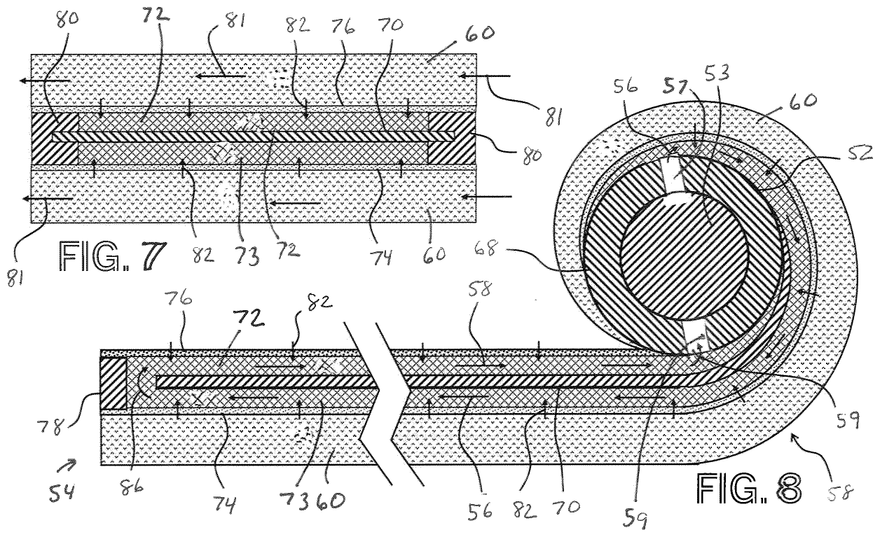

FIG. 8 shows a cross-sectional view of the manifold tube 52 and membrane web 54 including edge seal 80. The jelly roll structure is shown partially rolled to illustrate the details of internal fluid flow and details by which the hygroscopic (osmotic) fluid flow conduit is sandwiched between layers of feed flow conduit (material layer 60) when fully rolled. The barrier layer or material 70 is embedded within the first porous structural material layer 72 so as to formatively divide it into a first hygroscopic fluid flow conduit or channel 72B and a second hygroscopic fluid flow conduit or channel 72B. The barrier layer 70 is anchored to manifold tube 52 between ports 57 and ports 59 to direct fluid flow through first porous structural material layer sequentially through second hygroscopic fluid flow conduit or channel 72B and first hygroscopic fluid flow conduit or channel 72A by allowing them to connect with each other, as indicated by flow arrow 86, at the end of the web near edge seal 80 at the jelly roll's perimeter. The configuration ensures osmotic fluid flow (hygroscopic solution) throughout the entire length of the membrane web 54. Hygroscopic solution enters manifold tube 52 at end or entrance 68 and exits through tube exit ports or web entrance ports 57 and into the first porous structural material layer 72 at the commencement of the second hygroscopic fluid flow conduit 72B, as indicated by arrows 56. The hygroscopic solution or fluid then enters first porous structural material layer 72 at the second hygroscopic fluid flow channel 72B at the center of the jelly roll and flows through the first porous structural material layer 72 on one side of barrier layer 70 to the web's end and then crosses over as indicated by flow arrow 86 into the second hygroscopic fluid flow conduit 72A on the other side of barrier layer 70 and flows back through the first porous structural material layer 72 to the center where it exits the first porous structural material layer 72 through tube entrance ports or web exit ports 59 back into manifold tube 52.

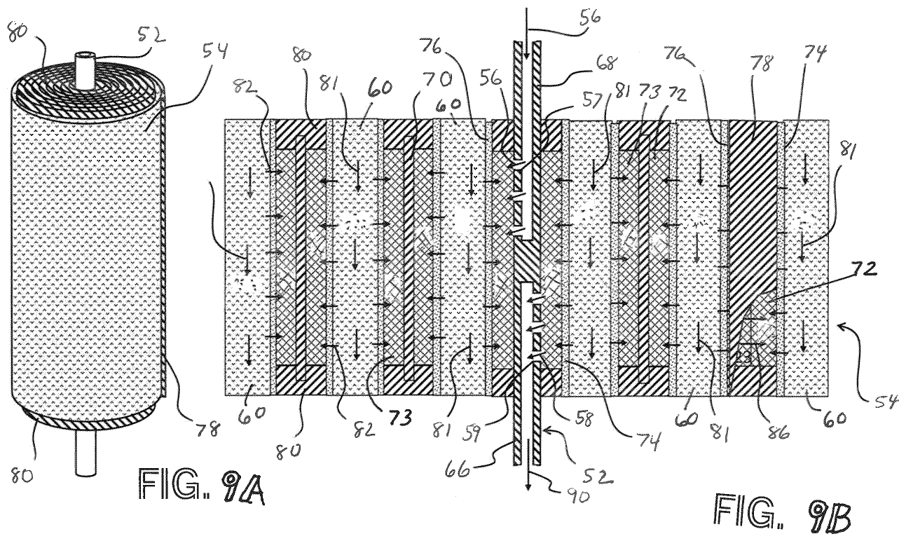

FIG. 9A illustrates a cross section of the assembled pressure retarded osmosis jelly roll membrane structure while FIG. 9B illustrates the rolled membrane structure. FIG. 9A shows the flow of feed fluid through the second porous structural material layer (feed flow conduit) 60 as indicated by arrows 81. Hygroscopic solution or fluid enters manifold tube 52 at entrance end 68 end and exits the manifold tube 52 through web entrance ports 57 into the first porous structural material layer (first hygroscopic fluid flow conduit channel) as indicated by arrows 56. The hygroscopic solution or fluid flows through or in plane within membrane web 54 through second hydroscopic fluid clow channel 72B to where it crosses over into the first hygroscopic fluid flow conduit 72A. The hygroscopic fluid flows in plane within membrane web 54 inside first porous structure material layer (hygroscopic fluid flow conduit) 72 to web exit port 59 where the hygroscopic fluid exits the membrane web 54 and enters back into manifold tube 52 where it then exits manifold tube 52 at end 66 as indicated by arrows 90. Osmosis membranes or layers 74 and 76 provide continuous coupling of the feed fluid (ambient air or seawater) in material layer (conduit) 60 to the hygroscopic fluid in material layers (channels) 72A and 72B. The osmosis membranes enable passage of the permeate constituent between the two fluids as indicated by arrows 82 as long as there is a permeate constituent concentration differential between the feed fluid and the hygroscopic fluid.

Porous structural material layers 61 and 72 are constructed of porous structural support materials that minimize resistance to fluid flow. In a pressure retarded osmosis applications, first porous structural material layer 72 would operate at significantly higher pressure than that of the second porous structural material layer 60. Configuring the materials in a layered jelly roll structure provides the mechanical stability needed to withstand high hydrostatic fluid pressure differentials, particularly a high hygroscopic fluid pressure within conduits in first porous structural material layer 72 versus a low feed fluid pressure within the second porous structural material layer 60.

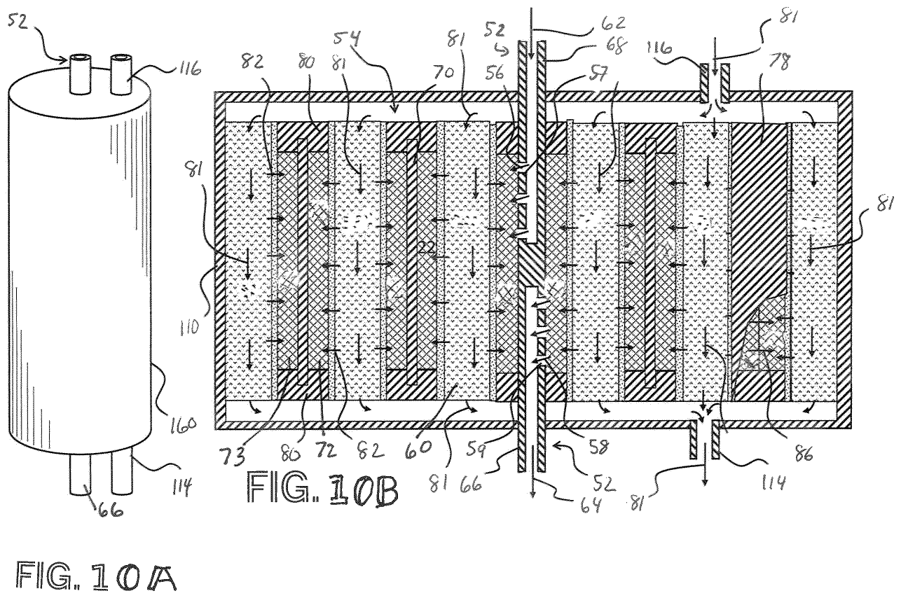

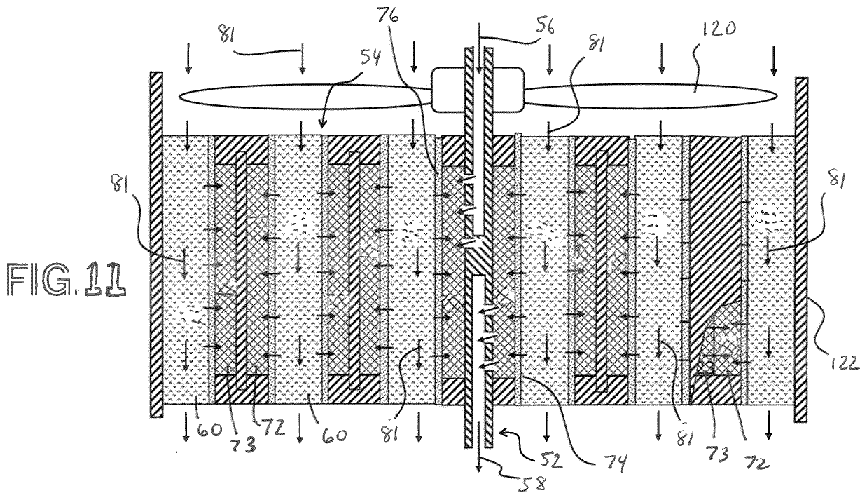

FIGS. 10A and 10B show a pressure retarded osmosis jelly roll membrane assembly mounted within housing 110. Feed fluid enters feed input 116 and passes though the spiraled membrane web 54 and exits through feed output port 114 as indicated by arrows 81. Hygroscopic fluid enters manifold tube 52 at entrance 68 end and exits through web input ports 57 into first porous structural material layer 72 as indicated by arrows 56. The hygroscopic fluid flows in plane within membrane web 54 inside first porous structural material layer within second hygroscopic fluid flow channel 72B to the end of barrier layer or separator 70 where the hygroscopic solution or osmotic fluid is allowed to cross over into first hygroscopic fluid flow channel 72A, as indicated by flow arrows 36. The hygroscopic solution flows in plane within membrane web 54 inside the first porous structural material layer 72 to osmotic fluid output or web exit ports 59 where it exits the first porous structural material layer 72 and enters back into manifold tube 52 and then exits manifold tube 52 at end 66. The continuous coupling of the feed fluid to the hygroscopic fluid by the osmosis membranes as the hygroscopic fluid flows through the full length of the jelly rolled web enables passage of the permeate constituent between the two fluids as indicated by arrows 82 when a permeate constituent concentration differential exists between the feed fluid and the hygroscopic fluid.

FIG. 11 shows the inclusion of forced air source 120 is illustrated as a blower to supply air as feed fluid to the pressure retarded osmosis membrane jelly roll assembly. Hygroscopic fluid that is low in water content enters manifold tube 52 at entrance end 68 passes through the first porous structural material layer 72 where it extracts moisture as previously described. Tubular housing 122 and the first and second porous structural materials to provide mechanical structural stability for containing pressurized osmotic fluid.

It should be understood that as an alternative to the single manifold tube 52 with the central plug 53 dividing the manifold tube 52 into two sections, an equivalent structure would be to have two separate manifold tube portions that accomplish the goal of passing fluid into the web and subsequently removing fluid from the web.

It is thus seen that a pressure retarded osmosis jelly roll membrane assembly is now provided to extract water from ambient air or seawater. Although the invention has been shown and described in its preferred form, it should be understood that modifications and variations may be made thereto without departure from its spirit and scope as set forth in the following claims.

1. A water extraction membrane assembly comprising:
a manifold tube having an entrance end, an exit end oppositely disposed from said entrance end, at least one web entrance port extending through said manifold tube and positioned between said entrance end and said exit end, at least one web exit port extending through said manifold tube and positioned between said at least one web entrance port and said exit end, and a central seal positioned within said manifold tube between said at least one web entrance port and said at least one web exit port, and
a membrane web positioned about said manifold tube in a spiral configuration, said membrane web having:
a first osmosis membrane coupled to said manifold tube;
a second osmosis membrane coupled to said manifold tube;
a barrier layer coupled to said manifold tube and positioned between said first osmosis membrane and said second osmosis membrane to form a first fluid flow conduit in fluid communication with said at least one web entrance port and a second fluid flow conduit in fluid communication with said at least one web exit entrance port and an end of said first fluid flow conduit;
a first porous structural material layer positioned within said first fluid flow conduit and said second fluid flow conduit, and
a second porous structural material layer positioned about said first osmosis membrane oppositely disposed from said first porous structural material layer.

2. The water extraction membrane assembly of claim 1 further comprising a housing containing said manifold tube and said membrane web.

3. The water extraction membrane assembly of claim 2 wherein said housing include a feed fluid input in fluid communication with said membrane web.

4. The water extraction membrane assembly of claim 1 wherein a plurality of like water extraction membranes are coupled to each other in series.

5. The water extraction membrane assembly of claim 1 further comprising a forced air source creating an air flow to said membrane web.

6. The water extraction membrane of claim 1 wherein said first osmosis membrane is a pressure retarded osmosis membrane.

7. The water extraction membrane of claim 1 further comprising a hygroscopic solution flowing through said manifold tube and said first porous structural material layer.

8. A water extraction membrane assembly comprising:
a manifold tube having a first portion and a second portion, said first portion having an entrance end and web entrance port extending through said first portion, said second portion having an exit end and web exit ports extending through said second portion, and
a membrane web coupled to said manifold tube and spiraling about said manifold tube, said membrane web having:
a first osmosis membrane coupled to said manifold tube;
a second osmosis membrane coupled to said manifold tube;
a barrier layer coupled to said manifold tube and positioned between said first osmosis membrane and said second osmosis membrane to form a first fluid flow conduit in fluid communication with said at least one web entrance port and a second fluid flow conduit in fluid communication with said at least one web exit entrance port and an end of said first fluid flow conduit;
a first porous structural material layer positioned within said first fluid flow conduit and said second fluid flow conduit, and
a second porous structural material layer positioned about said first osmosis membrane oppositely disposed from said first porous structural material layer.

9. The water extraction membrane assembly of claim 8 further comprising housing containing said manifold tube and said membrane web.

10. The water extraction membrane assembly of claim 9 wherein said housing include a feed fluid input in fluid communication with said membrane web.

11. The water extraction membrane assembly of claim 8 wherein a plurality of like water extraction membranes are coupled to each other in series.

12. The water extraction membrane assembly of claim 8 further comprising a forced air source creating an air flow to said membrane web.

13. The water extraction membrane of claim 8 wherein said first osmosis membrane is a pressure retarded osmosis membrane.

14. The water extraction membrane of claim 8 further comprising a hygroscopic solution flowing through said manifold tube and said first porous structural material layer.
